(19) United States
(12) Patent Application Publication
(10) Pub. No.: US 2014/0192553 A1
(43) Pub. Date: Jul. 10, 2014

(54) BACKLIGHT MODULE WITH LIGHT-VARYING STRUCTURES FORMED IN A LIGHT GUIDE PLATE

(71) Applicant: WISTRON CORP., New Taipei City (TW)

(72) Inventors: Chin-Yung Liu, New Taipei City (TW); Ya-Ping Niu, New Taipei City (CN)

(73) Assignee: WISTRON CORP., New Taipei City (TW)

(21) Appl. No.: 13/896,198

(22) Filed: May 16, 2013

(30) Foreign Application Priority Data
Jan. 6, 2013 (CN) 201310003805.7

(51) Int. Cl. F21V 8/00

(52) U.S. Cl. CPC G02B 6/0035
USPC 362/606

(57) ABSTRACT

A backlight module is disclosed. A light guide plate includes a main body and a plurality of light-varying structures. The main body includes a top surface and a bottom surface. The light-varying structures are formed in the main body. A first optical film is formed on the top surface of the main body of the light guide plate. A second optical film is formed on the bottom surface of the main body of the light guide plate. At least one light source is adjacent to the light guide plate, outputting light into the light guide plate.

### CROSS REFERENCE TO RELATED APPLICATIONS

This Application claims priority of China Patent Application No. 201310003805.7, filed on Jan. 6, 2013, the entirety of which is incorporated by reference herein.

### BACKGROUND OF THE INVENTION

1. Field of the Invention

The invention relates to a backlight module, and more particularly to a backlight module with a reduced size and reduced manufacturing costs.

2. Description of the Related Art

A conventional backlight module comprises a light guide plate, one or more reflective films, one or more diffusion films, and one or more prism films. To provide a superior backlight effect from the backlight module, outer surfaces, such as, top and bottom surfaces, of the light guide plate are formed with a plurality of light-varying structures. A route of light transmitting in the light guide plate can be changed by the light-varying structures. Here, the light-varying structures may be bumps, recesses, or the like.

The conventional backlight module has many drawbacks as follows. As the light-varying structures are formed on the outer surfaces of the light guide plate, optical films, such as, reflective films, diffusion films, and prism films, must be stacked on the light-varying structures, such that an overall size and manufacturing costs of the conventional backlight module cannot be reduced. Moreover, as the light-varying structures can be formed only on the outer surfaces of the light guide plate, an optical display effect provided by the conventional backlight module is limited. Furthermore, as the conventional backlight module is assembled from the light guide plate, reflective films, diffusion films, and prism films, assembly thereof is complex and inconvenient.

### BRIEF SUMMARY OF THE INVENTION

A detailed description is given in the following embodiments with reference to the accompanying drawings.

An exemplary embodiment of the invention provides a backlight module comprising a light guide plate, a first optical film, a second optical film, and at least one light source. The light guide plate comprises a main body and a plurality of light-varying structures. The main body comprises a top surface and a bottom surface. The light-varying structures are formed in the main body. The first optical film is formed on the top surface of the main body of the light guide plate. The second optical film is formed on the bottom surface of the main body of the light guide plate. The light source is adjacent to the light guide plate, outputting light into the light guide plate.

The light-varying structures are provided with a same horizontal height in the

main body of the light guide plate.

The light-varying structures are provided with different horizontal heights in the

main body of the light guide plate.

The light-varying structures are provided with a hemispherical shape.

The light-varying structures are provided with a cylindrical shape.

The light-varying structures are provided with a prismatic shape.

The light-varying structures are provided with a pyramidal shape.

The first optical film comprises a reflective film, a diffusion film, or a prism film.

The second optical film comprises a reflective film, a diffusion film, or a prism film.

The first and second optical films are respectively coated on the top and bottom surfaces.

### BRIEF DESCRIPTION OF THE DRAWINGS

The invention can be more fully understood by reading the subsequent detailed description and examples with references made to the accompanying drawings, wherein:

FIG. 1 is a schematic cross section of a backlight module of a first embodiment of the invention;

FIG. 2 is a top view of a light guide plate of the backlight module of the invention;

FIGS. 3A to 3F show various types of light-varying structures formed in the

light guide plate of the backlight module of the invention; and

FIG. 4 is a schematic cross section of a backlight module of a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

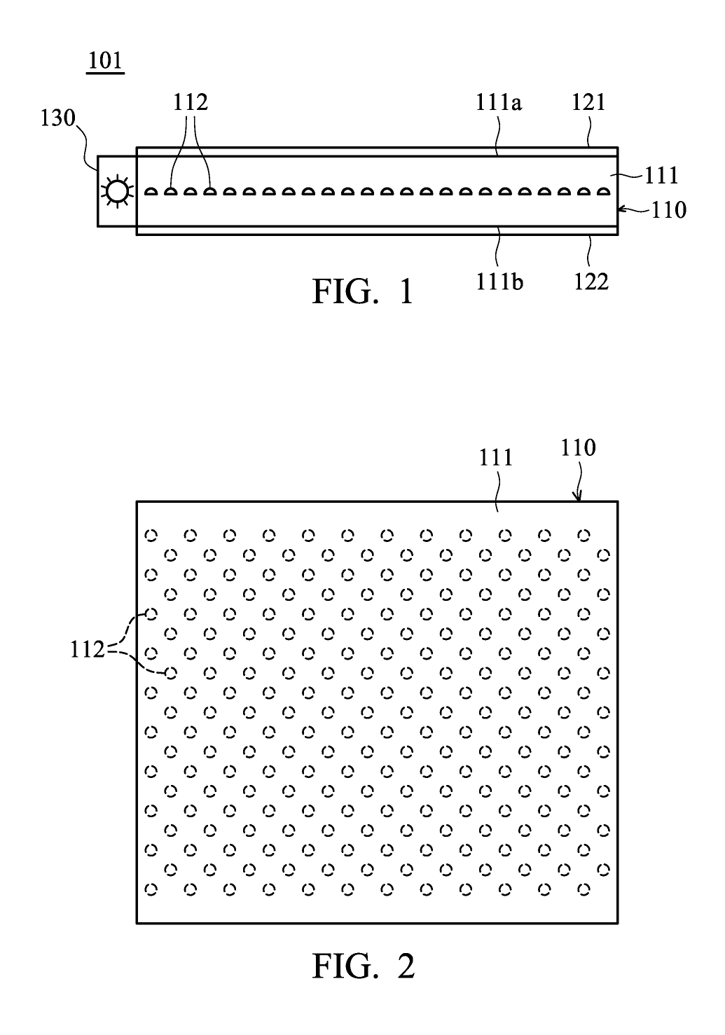

Referring to FIG. 1, a backlight module 101 comprises a light guide plate 110, a first optical film 121, a second optical film 122, and a light source 130.

As shown in FIG. 1 and FIG. 2, the light guide plate 110 comprises a main body 111 and a plurality of fight-varying structures 112. As shown in FIG. 1, the main body 111 comprises a top surface 111a and a bottom surface 111b, and the light-varying structures 112 are formed in the main body 111.

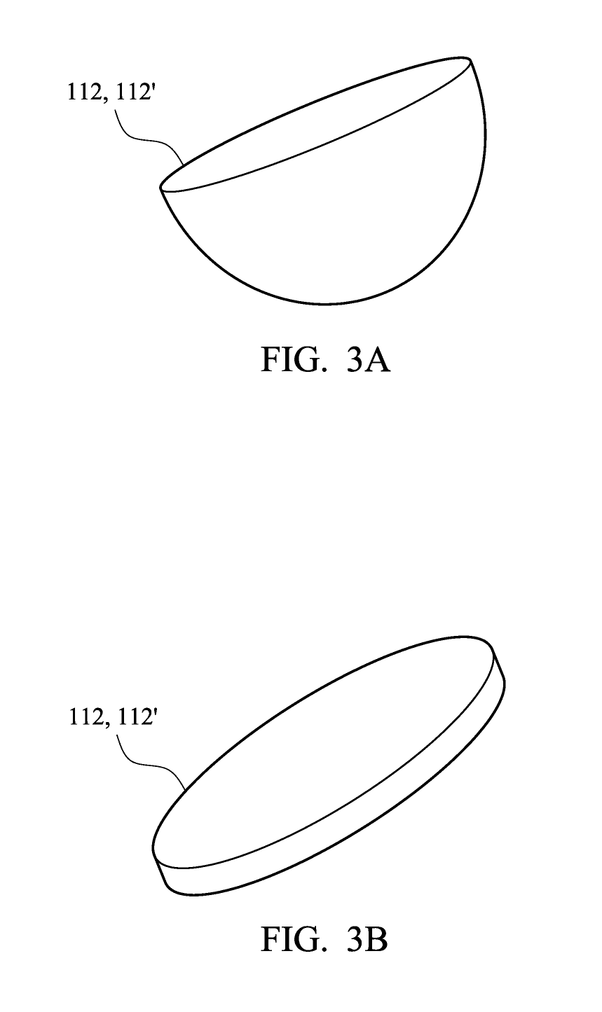

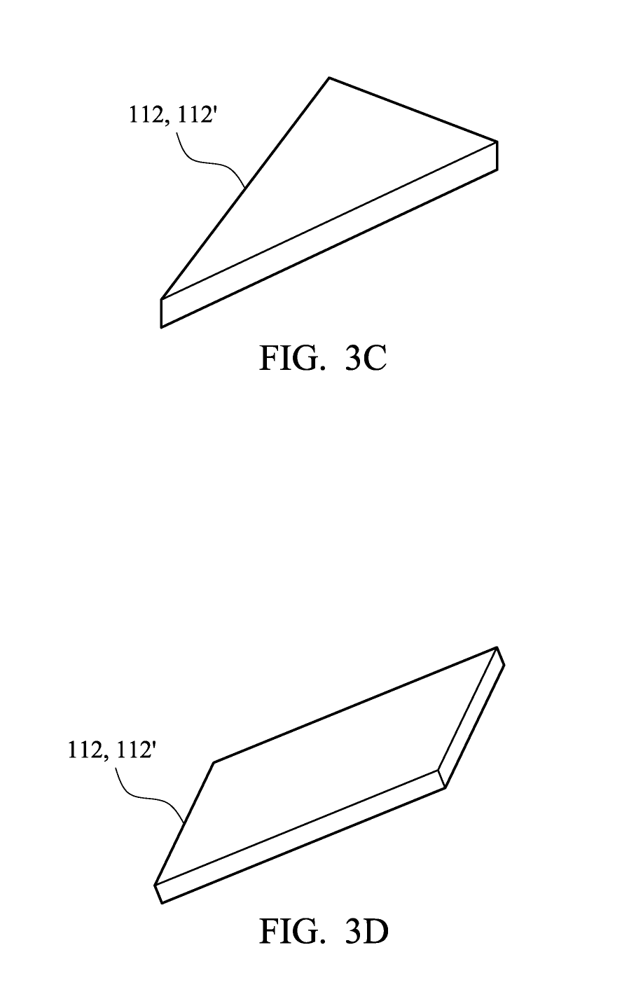

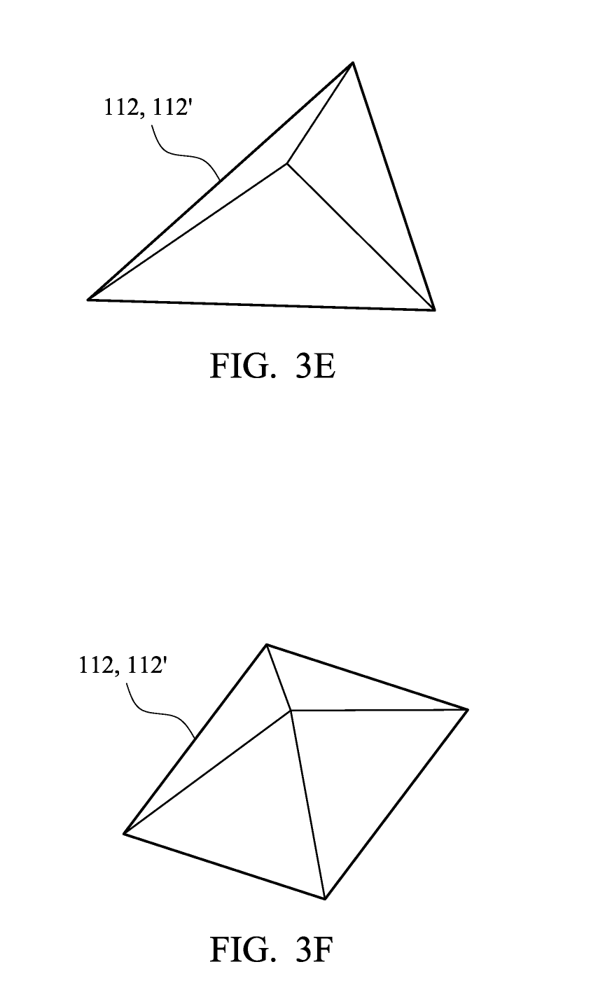

In this embodiment, the light-varying structures 112 are provided with a same horizontal height in the main body 111 of the light guide plate 110. Namely, the light-varying structures 112 are arranged in the main body 111 with a coplanar manner. Here, the light-varying structures 112 may be formed in the main body 111 using a conventional Pico IR Laser method. Moreover, the shape of the light-varying structures 112 may be designed according to optical requirements. For example, the light-varying structures 112 may be provided with a hemispherical shape (as shown in FIG. 3A), a cylindrical shape (as shown in FIG. 3B), a triangular prismatic shape (as shown in FIG. 3C), a rectangular prismatic shape (as shown in FIG. 3D), a triangular pyramidal shape (as shown in FIG. 3E), a rectangular pyramidal shape (as shown in FIG. 3F), or a V-cut shape, but are not limited thereto.

Moreover, in this embodiment, the light guide plate 110 may be composed of Polymethylmethacrylate (PMMA), Poly Carbonate (PC), or PS/Silicone. The light guide plate 110 may be also composed of optical-grade plastic or glass.

As shown in FIG. 1, the first optical film 121 is formed on the top surface 111a of the main body 111 of the light guide plate 110.

The second optical film 122 is formed on the bottom surface 111b of the main body 111 of the light guide plate 110.

In this embodiment, the first optical film 121 and second optical film 122 may be a reflective film, a diffusion film, or a prism film, according to the optical requirements. Additionally, the thickness of the first optical film 121 and second optical film 122 may be changed, according to the optical requirements.

Accordingly, as the light guide plate 110 is provided with the inlaid light-varying structures 112, the light guide plate 110, first optical film 121, and second optical film 122 can be manufactured with an integrated manner.

### Second Embodiment

Elements corresponding to those in the first embodiment share the same reference numerals.

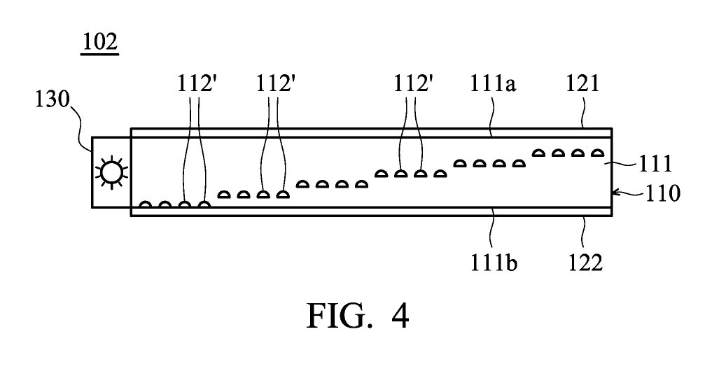

Referring to FIG. 4, a backlight module 102 comprises a light guide plate 110, a first optical film 121, a second optical film 122, and a light source 130. The major difference between this embodiment and the first embodiment is that arrangements of the light-varying structures in the main body of the light guide plate are different. Specifically, in this embodiment, the light-varying structures 112′ are provided with different horizontal heights in the main body 111 of the light guide plate 110. Namely, the light-varying structures 112′ are arranged in the main body 111 with a non-coplanar manner.

Similarly, the light-varying structures 112′ may be formed in the main body 111 using a conventional Pico IR Laser method, and the light-varying structures 112′ may be provided with a hemispherical shape (as shown in FIG. 3A), a cylindrical shape (as shown in FIG. 3B), a triangular prismatic shape (as shown in FIG. 3C), a rectangular prismatic shape (as shown in FIG. 3D), a triangular pyramidal shape (as shown in FIG. 3E), a rectangular pyramidal shape (as shown in FIG. 3F), or a V-cut shape, but are not limited thereto.

Structure, disposition, and function of other elements in this embodiment are the same as those in the first embodiment, and explanation thereof is omitted for brevity.

Similarly, as the light guide plate 110 is provided with the inlaid light-varying structures 112′, the light guide plate 110, first optical film 121, and second optical film 122 can be manufactured with an integrated manner.

In conclusion, the backlight modules 101 and 102 have the following advantages. As the light guide plate 110, first optical film 121, and second optical film 122 can be manufactured into an integrated piece, assembly of the backlight modules 101 and 102 is simplified. Moreover, as the light-varying structures 112 and 112′ are formed in the main body 111 of the light guide plate 110 and the first optical film 121 and second optical film 122 are directly coated on the surfaces of the main body 111 of the light guide plate 110, an overall size and manufacturing costs of the backlight modules 101 and 102 can be effectively reduced. Furthermore, as the position of the light-varying structures 112 and 112′ in the main body 111 of the light guide plate 110 can be adjusted per requirements, the backlight modules 101 and 102 can provide an extensive or versatile optical display effect. Additionally, as the light guide plate 110, first optical film 121, and second optical film 122 are tightly integrated together, optical loss of the light during transmission is reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a light guide plate comprising a main body and a plurality of light-varying structures, wherein the main body comprises a top surface and a bottom surface, and the light-varying structures are formed in the main body;
a first optical film, formed on the top surface of the main body of the light guide plate;
a second optical film formed on the bottom surface of the main body of the light guide plate; and
at least one light source adjacent to the light guide plate, outputting light into the light guide plate.

2. The backlight module as claimed in claim 1, wherein the light-varying structures are provided with a same horizontal height in the main body of the light guide plate.

3. The backlight module as claimed in claim 1, wherein the light-varying structures are provided with different horizontal heights in the main body of the light guide plate.

4. The backlight module as claimed in claim 1, wherein the light-varying structures are provided with a hemispherical shape.

5. The backlight module as claimed in claim 1, wherein the light-varying structures are provided with a cylindrical shape.

6. The backlight module as claimed in claim 1, wherein the light-varying structures are provided with a prismatic shape.

7. The backlight module as claimed in claim 1, wherein the light-varying structures are provided with a pyramidal shape.

8. The backlight module as claimed in claim 1, wherein the first optical film comprises a reflective film, a diffusion film, or a prism film.

9. The backlight module as claimed in claim 1, wherein the second optical film comprises a reflective film, a diffusion film, or a prism film.

10. The backlight module as claimed in claim 1, wherein the first and second optical films are respectively coated on the top and bottom surfaces.
